(19) United States
(12) Patent Application Publication
(10) Pub. No.: US 2026/0227018 A1
(43) Pub. Date: Aug. 6, 2026

(54) SIDE WALL SEAL FOR PIPING

(71) Applicant: Roof Goose Vent LLC, North Kingstown, RI (US)

(72) Inventor: Jack F. KING, JR., North Kingstown, RI (US)

(73) Assignee: Roof Goose Vent LLC, North Kingstown, RI (US)

(21) Appl. No.: 19/456,671

(22) Filed: Jan. 22, 2026

Related U.S. Application Data
(60) Provisional application No. 63/753,182, filed on Feb. 3, 2025.

(51) Int. Cl. F16L 41/12; F16L 5/02

(52) U.S. Cl. CPC F16L 41/12; F16L 5/027

(57) ABSTRACT

There is disclosed a side wall seal for piping exiting the side wall of a building comprising a flexible gasket, a bar inserted into the gasket, a bottom outlet trough attached to the gasket and a top cover which mates with the bottom outlet trough. The bar seats on the bottom outlet trough and provides horizontal pressure of the rubber gasket to provide a good seal. Piping exits a building side wall on the bottom outlet trough and is guided downward at an angle. The bottom outlet trough provides support to the piping. The bottom outlet trough, bar and gasket are attached to the building side wall by fasteners. The top cover is placed over the bottom outlet trough, gasket and bar to cover the piping, to complete the waterproof seal, and to cover, support and protect the piping.

### RELATED APPLICATION

This application claims the benefit of U.S. Provisional Application Ser. No. 63/753,182, filed Feb. 3, 2025, entitled “Side Wall Seal For Piping,”which is incorporated herein by reference in its entirety.

### FIELD OF THE INVENTION

The present invention relates to a side wall seal for piping. More specifically, the invention relates to a side wall seal for piping for pipes exiting a building at a right angle to the side wall of the building.

### BACKGROUND OF THE INVENTION

Pipes exit the side wall of buildings and require a water resistant seal. Such pipes may be for linesets, e.g., for an air conditioning system; for a gas line; for a drain line; or for similar pipes exiting the side wall of a building. The seal may be for a single pipe or for multiple pipes.

Seals for piping are known in the prior art such as the Airex Titan TGS Series and TRS Series Lineset Wall Seal System comprising a rectangular box covering an opening in a building side wall through which a pipe extends and having a rubber gasket fitted over the pipe and against the box to provide a seal.

Additionally, an improved side wall seal is disclosed in the inventor's U.S. application Ser. No. 17/954,952, filed Sep. 28, 2022, entitled “Side Wall Seal For Piping,” which is incorporated herein by reference. This seal is sold by Roof Goose Vent under the trademark RoofGooseVent Side Wall Seal.

While the prior art seals may provide some benefits, improvement is possible, including providing a water resistant seal which is inexpensive and easy to use. The present invention addresses these issues.

### SUMMARY OF THE INVENTION

A primary object of the invention is to provide a side wall seal for piping.

Another primary object of the invention is to provide a water resistant seal for piping exiting from a side wall of a building, including for a single pipe or for multiple pipes.

Another primary object of the invention is to provide a side wall seal for piping which is water resistant and useful for pipes exiting a building side wall at a right angle.

Another primary object of the invention is to provide a side wall seal for piping having a 90 degree bend.

Another primary object of the invention is to provide a side wall seal for piping having a 90 degree bend which provides a clamping effect which helps in providing support to the piping.

Another primary object of the invention is to provide a side wall seal for piping having a 90 degree bend which includes a bottom outlet trough for receiving the piping and which acts as a mandrel for malleable piping and a worker can hand form the bend with smaller diameter piping.

Another primary object of the invention is to provide a side wall seal for piping wherein the fasteners for fastening the side wall seal to a building side wall are covered by a top cover.

Another primary object of the invention is to provide a side wall seal for piping which is sized to fit on a typical geometry of house siding without being spaced over two pieces of siding.

Another primary object of the invention is to provide a side wall seal for piping which is water resistant and which may be used for retrofit installation for existing pipes or for pipes in new construction.

Another primary object of the invention is to provide a side wall seal for piping which is water resistant and can accept a piping accessory comprising a UV resistant rigid cover to protect, for example, an outer insulation layer of a refrigerator line set.

Another primary object of the invention is to provide a side wall seal for piping which is water resistant and is made of plastic.

The invention is directed to a side wall seal for piping comprising a bottom outlet trough, a flexible gasket for attachment to a building side wall and to which the bottom outlet trough is connected, a top cover which mates with the bottom outlet trough and a bar which seats on the bottom outlet trough and provides horizontal pressure on the rubber gasket to provide a good seal. The piping exits the side wall of a building through the gasket on the bottom outlet trough and is guided downward at a 90 degree angle. The bottom outlet trough provides support to the piping. The bar is placed against the gasket and seats at the top of the bottom outlet trough. The bottom outlet trough, the bar and the gasket are attached to the building side wall by fasteners. The top cover is placed over the gasket, bar and bottom outlet trough to cover the piping and to complete the waterproof seal and to cover, support and protect the piping. The cover also covers the fasteners to present a clean look.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1A is a perspective front and side view of the side wall seal for piping of the present invention.

FIG. 1B is a perspective rear and side view of the side wall seal of FIG. 1A.

FIG. 1C is a side view of the side wall seal of FIG. 1A.

FIG. 1D is a top view of the side wall seal of FIG. 1A.

FIG. 1E is a front view of the side wall seal of FIG. 1A.

FIG. 1F is a rear view of the side wall seal of FIG. 1A.

FIG. 1G is a cross-section taken along lines A-A of FIG. 1F.

FIG. 2A is a perspective front and side exploded view of side wall seal of FIG. 1A.

FIG. 2B is a perspective rear and side exploded view of the side wall seal of FIG. 2A.

FIG. 2C is a side exploded view of the side wall seal of FIG. 2A.

FIG. 2D is a top exploded view of the side wall seal of FIG. 2A.

FIG. 2E is a front exploded view of the side wall seal of FIG. 2A.

FIG. 3A is a perspective front and side view of the bottom outlet trough of the side wall seal of FIGS. 1A and 2A.

FIG. 3B is a perspective rear and side view of the bottom outlet trough of FIG. 3A.

FIG. 3C is a side view of FIG. 3A.

FIG. 3D is a top view of FIG. 3A.

FIG. 3E is a front view of FIG. 3A.

FIG. 3F is a rear view of FIG. 3A.

FIG. 4A is a perspective top and side view of the top cover of FIGS. 1A and 2A.

FIG. 4B is a perspective rear and side view of the top cover of FIGS. 1A and 2A.

FIG. 4C is a side view of FIG. 4A.

FIG. 4D is a top view of FIG. 4A.

FIG. 4E is a front view of FIG. 4A.

FIG. 4F a rear view of FIG. 4A.

FIG. 5A is a perspective front and top view of the bar of the side wall seal of FIG. 2A.

FIG. 5B is a perspective front, bottom and end view of the bar of the side wall seal of FIG. 2A.

FIG. 5C is a front view of FIG. 5A.

FIG. 5D is a top view of FIG. 5A.

FIG. 5E is an end view of FIG. 5A.

FIG. 6A is a perspective front and side view of the gasket of FIG. 2A.

FIG. 6B is another perspective front and side view of the gasket of FIG. 2A.

FIG. 6C is a front view of FIG. 6A.

FIG. 6D is a side view of FIG. 6A.

FIG. 6E is a top view of FIG. 6A.

FIG. 7A is a perspective front and side view of the side wall seal of FIG. 1A attached to a building side wall having multiple pieces of siding and an uneven surface.

FIG. 7B is a front view of FIG. 7A.

FIG. 7C is a side view of FIG. 7A.

FIG. 8A is a perspective front and side view of the side wall seal of FIG. 1A attached to a building side wall having an even surface.

FIG. 8B is a front view of FIG. 8A.

FIG. 8C is a side view of FIG. 8A.

### DETAILED DESCRIPTION OF THE PREFERRED EMBODIMENTS

The invention is directed to a side wall seal for piping. Specifically, a water resistant seal is required for piping exiting from a side wall from a building, including for a single pipe or for multiple pipes. The device is useful for pipes exiting a building side wall at a right angle to the side wall. The device may be used for retrofit installation for existing piping or for piping in new construction installation. The seal is made of a plastic such as, but not limited to, PVC (polyvinyl chloride) or HDPE (high density polyethylene).

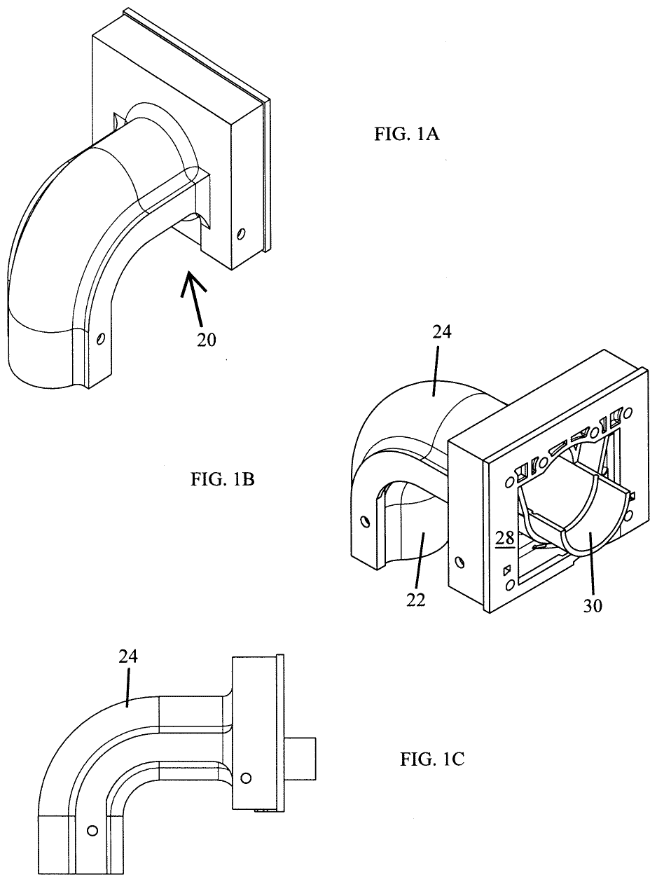

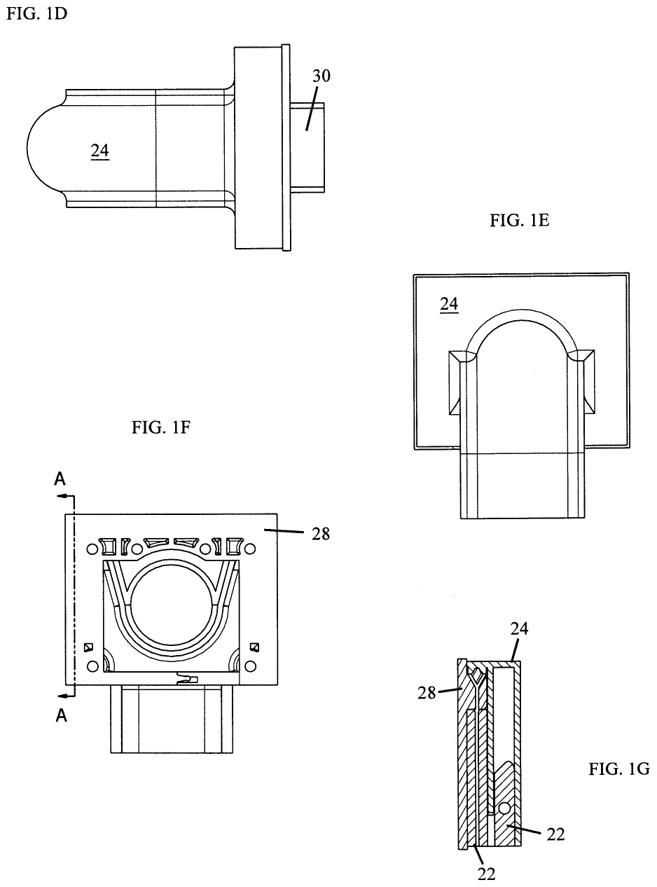

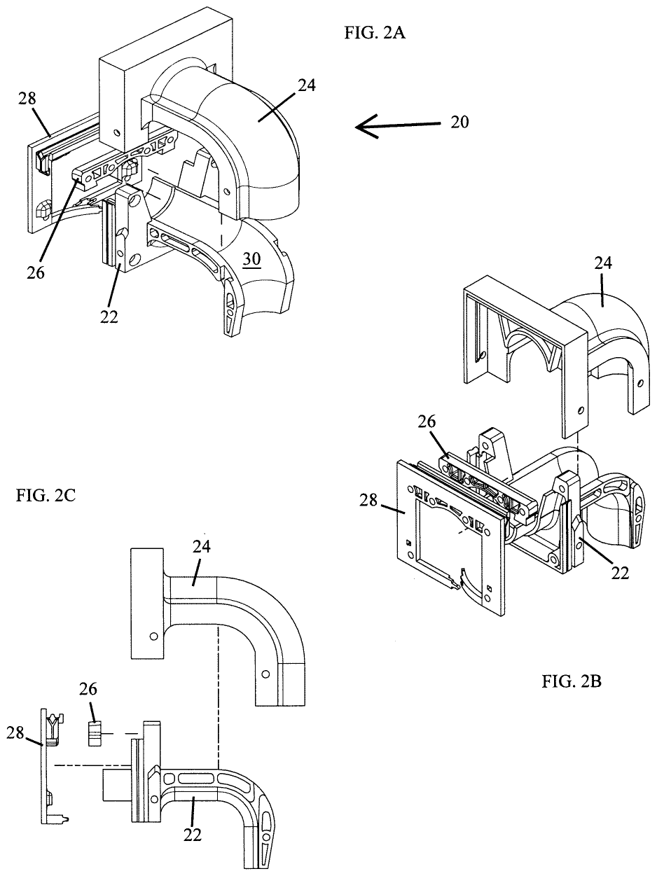

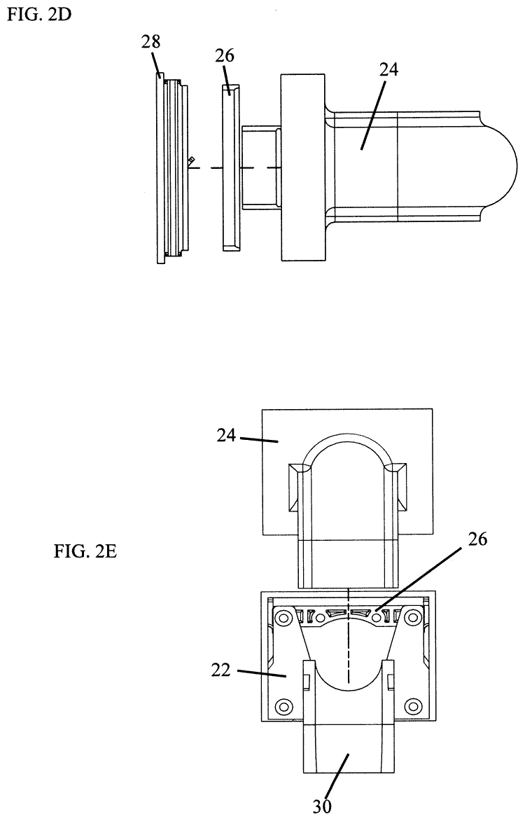

The side wall seal is shown in FIGS. 1-8. Referring, for example, to FIGS. 2A-2E, the seal 20 includes a bottom outlet trough 22, a top cover 24, a bar 26 and a flexible gasket 28. The flexible gasket 28 is to be attached to a building side wall. The bar 26 is inserted into the gasket 28. The bottom outlet trough 22 is thereafter connected to the gasket 28 and bar 26 seats on the back of the bottom wall trough 22. The piping exits the building side wall through the gasket 28 and onto the bottom outlet trough 22 and is guided at a downward angle, e.g., a 90 degree angle. The bottom outlet trough provides support to the piping. The bar 26 seats on the top of the back wall of the bottom outlet trough. The bottom outlet trough 22, bar 26 and gasket 28 are attached to the building side wall by fasteners. The top cover 24 is placed over the bottom outlet trough, bar and gasket to cover the piping and to complete the waterproof seal which covers, supports and protects the piping. The cover 24 also covers the fasteners to present a clean look.

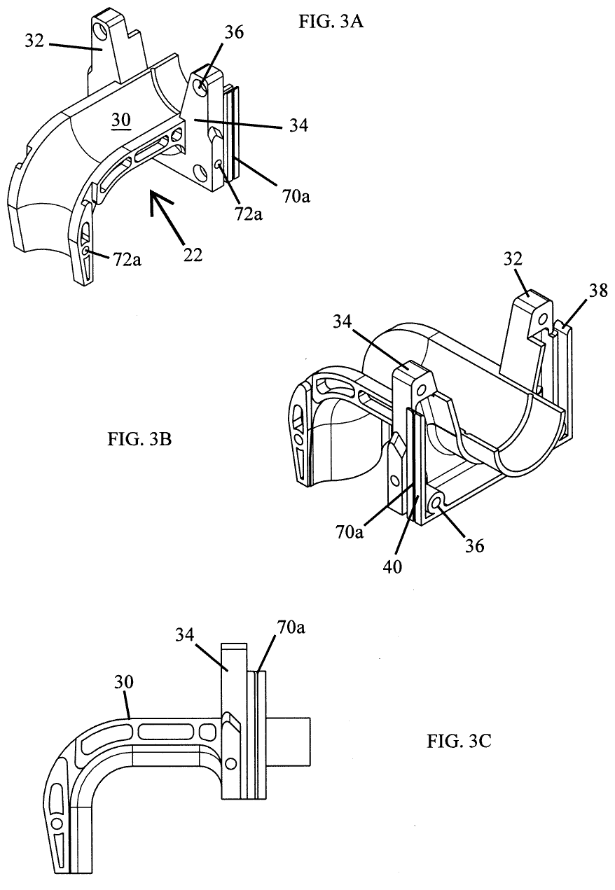

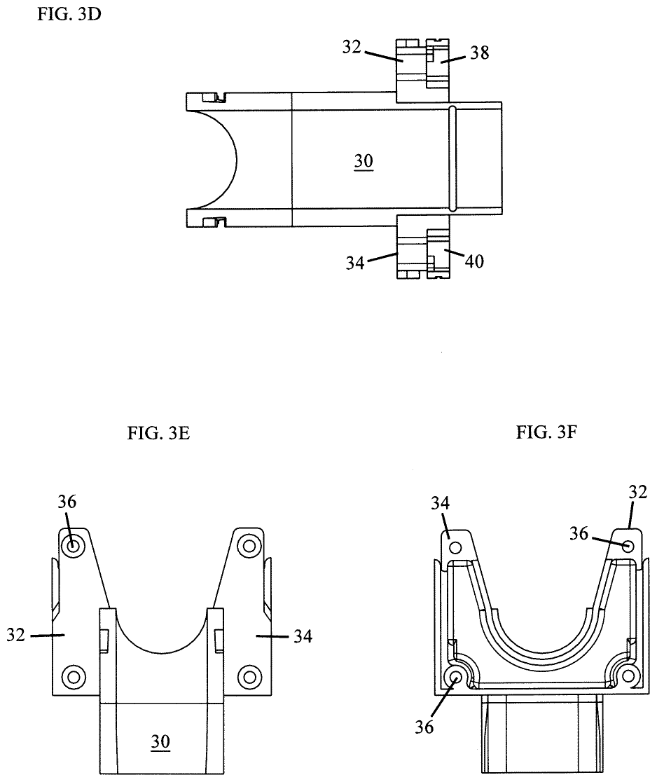

Referring to FIGS. 2A-2E and FIGS. 3A-3F, the bottom outlet trough 22 includes a trough portion 30 for receiving piping such as HVAC piping. The piping exits the building on the trough 30. The trough bends at a downward angle, e.g., a 90 degree angle. The bottom outlet trough includes stanchions 32 and 34 having apertures 36 for receiving fasteners. Attached at the back of stanchions 32 and 34 are support members 38 and 40 on which the bar 26 seats and which also receives part of top cover 24. The bottom outlet trough 22 will provide support to the HVAC piping or other piping and will guide the piping at the downward angle.

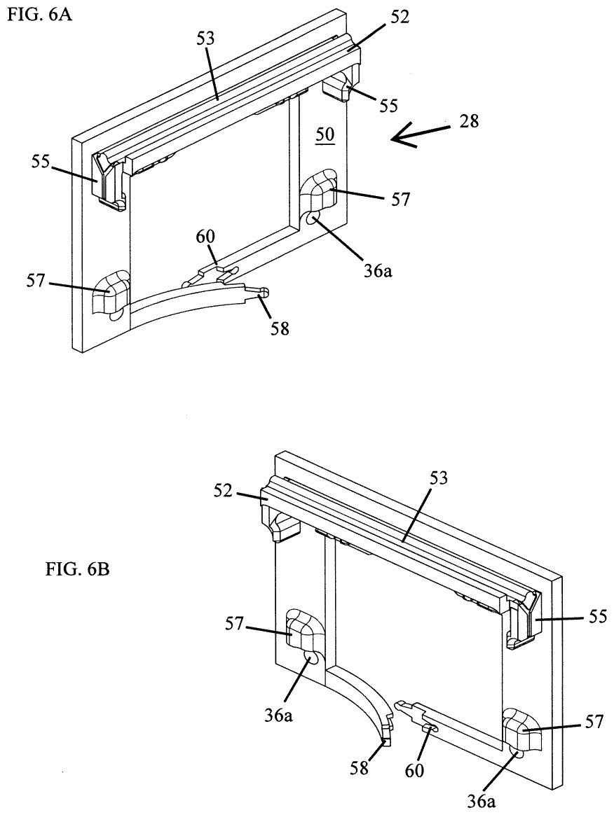

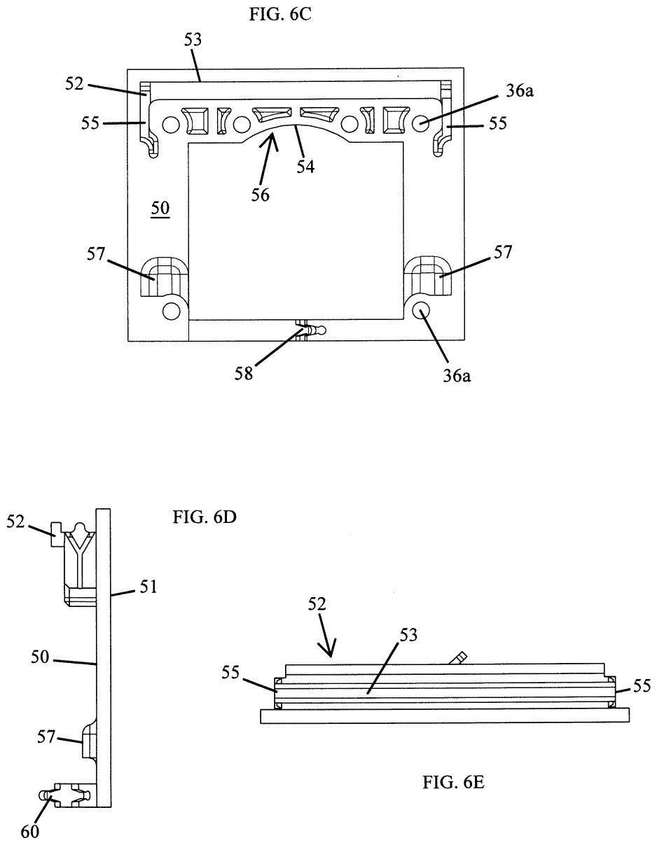

Referring to FIGS. 2A-2E and FIGS. 6A-6E, there is shown the flexible gasket 28. The gasket 28 is flexible and provides a seal between the building side wall and the bottom outlet trough 22. The bottom outlet trough 22 will be attached to the gasket 28 and to the building side wall by fasteners extending through apertures 36 of the bottom outlet trough 22 and through corresponding apertures 36a of the gasket. Referring to FIGS. 6A-6E, there is a front wall 50 and rear wall 51 of gasket 28. Front wall 50 includes bar receptacle 52 for receiving and holding bar 26 on the underside thereof by corresponding geometry and friction fit. Bar receptacle 52 includes a top wall 53, bottom wall 54 and legs 55 forming an open area 56 for receiving bar 26 by friction fit. There are also outlets 57 for engaging the back wall of bottom outlet trough 22. Bar receptacle 52 with bar 26 seats on supports 38 and 40 of bottom outlet trough 22. The gasket includes a tongue and groove connection means 58 and 60 (on front and back sides) for allowing the gasket to be opened to fit over and around the piping and thereafter secured and closed.

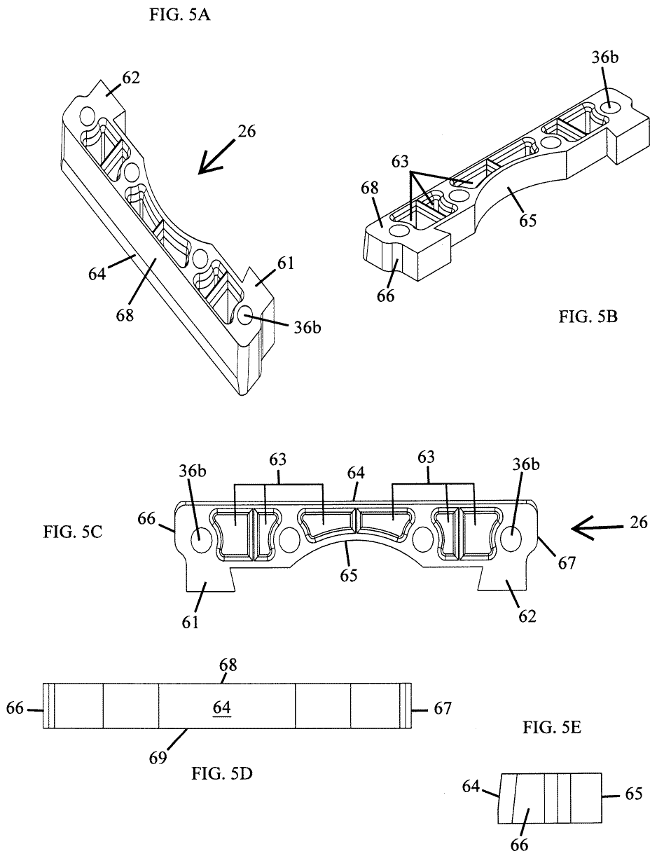

Referring to FIGS. 2A-2E and FIGS. 5A-5E, there is shown bar 26. Bar 26 includes legs 61 and 62 which fit into gasket 28 and seat on support members 38 and 40 of the rear wall of the bottom outlet trough 22. The bar 62 further includes openings 63 for flexibility and a lighter weight. As apparent, there are a top wall 64, bottom wall 65, side walls 66,67, front wall 68 and rear wall 69. There are apertures 36b through which the fasteners go through in attaching the side wall seal to the building. The bar 26 provides horizontal pressure between the back of bottom outlet trough 22 and gasket 28 to provide a good seal. After the gasket 28 is placed over and around the piping, bar 26 is inserted into gasket 28. The bottom outlet trough 22 is mated against the gasket 28 with bar 26. Fasteners are then inserted through apertures 36, 36a and 36b to attach trough 22 to the building side wall.

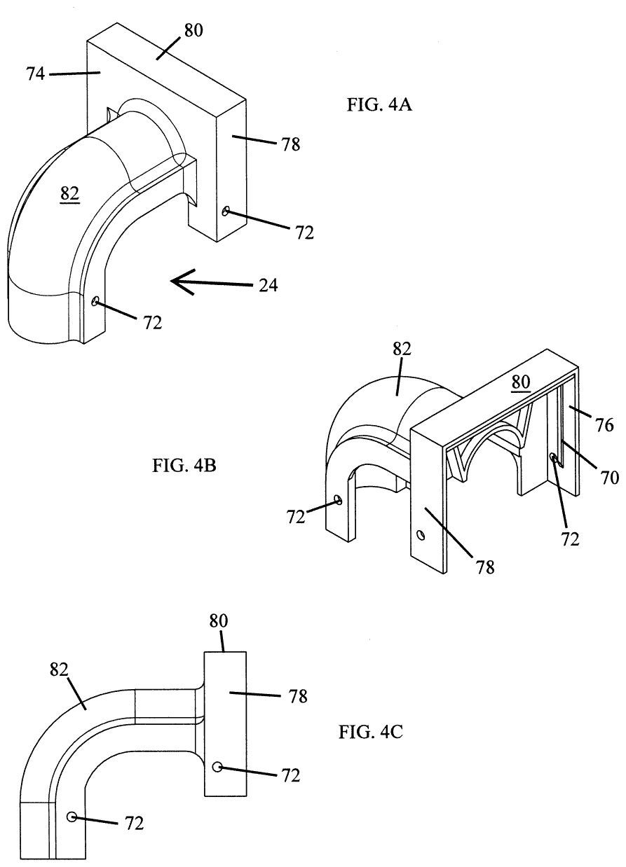

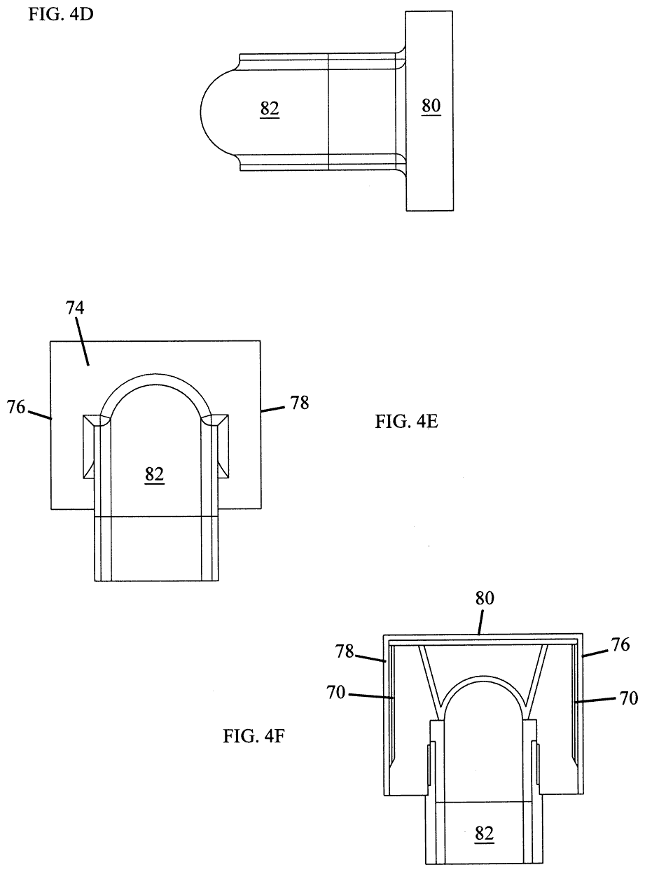

Referring to FIGS. 2A-2E and FIGS. 4A-4E, there is shown top cover 24 which fits on bottom outlet trough 22 and attached thereto by ribs 70 mating with corresponding grooves 70a in supports 38 and 40 and friction fit and at the side wall by fasteners through apertures 72 and corresponding apertures 72a of bottom outlet trough 22. The top cover 24 includes a front wall 74, side walls 76,78, top wall 80 and upper trough portion 82 which mates with trough 30 and encloses the piping. Cover 24 covers the fasteners for a clean look and to avoid anything snagging on the fasteners. The completed side wall seal, as shown for example in FIGS. 1A-1F, provides a water resistant seal to the building side wall and covers, supports and protects the piping.

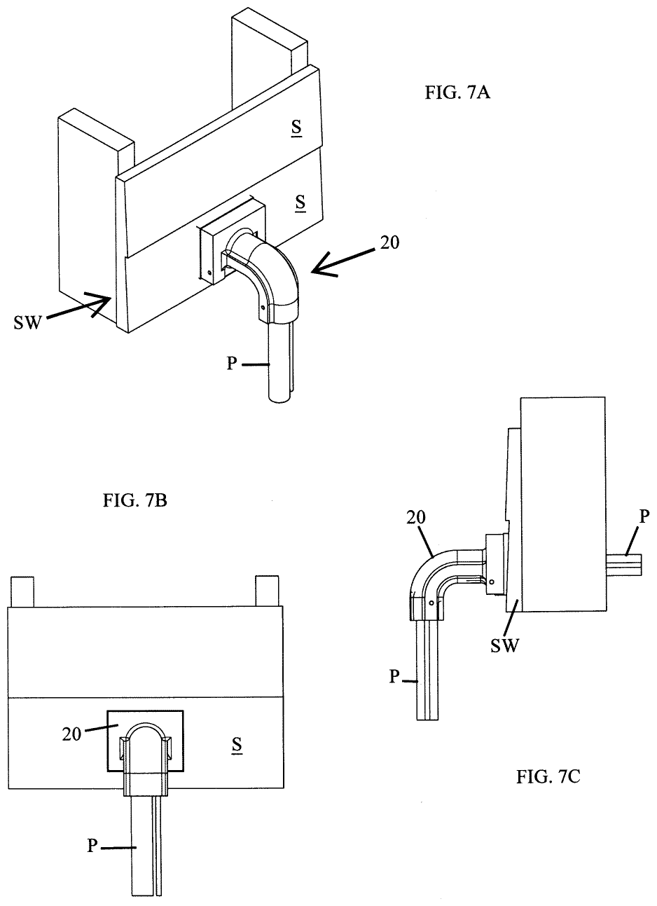

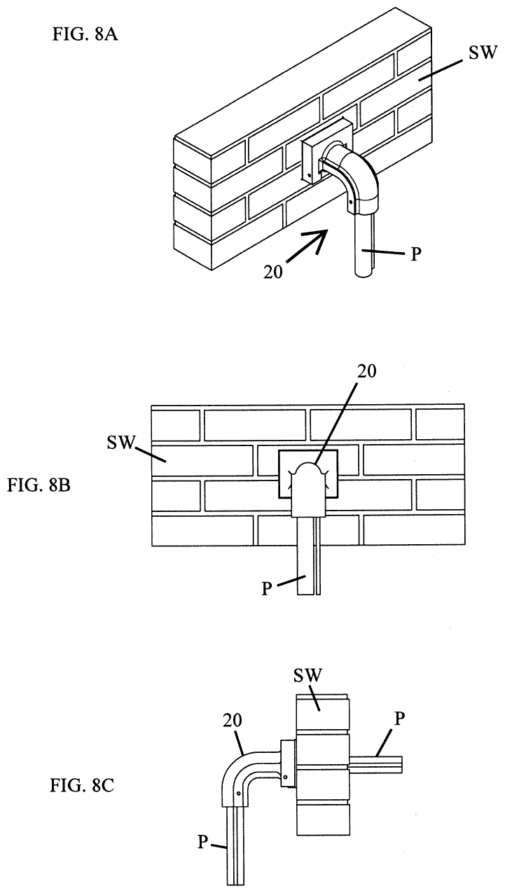

Referring to FIGS. 7A-7C, there is shown a building side wall SW with side wall seal 20 covering piping P. The side wall seal fits on a single siding S of the SW. FIGS. 8A-8C show the side wall seal 20 attached to a building side wall having a uniform surface.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A side wall seal for piping exiting a building side wall comprising
-a flexible gasket adapted to be attached to the building side wall and having an opening through which the piping extends,
a bar adapted to fit into the gasket,
a bottom outlet trough adapted to be attached to the gasket, the bottom outlet trough having a bottom trough extending at an angle downward and adapted to receive the piping, and
-a top cover adapted to fit over the bottom outlet trough and having an upper trough corresponding to the bottom trough,
wherein the gasket is connected to the building, the bar seats in the gasket and the bottom outlet trough, and the top cover fits over the bottom outlet trough to cover and seal the piping exiting the building side wall.

2. The side wall seal of claim 1 wherein the side wall seal is plastic.

3. The side wall seal of claim 1 wherein the bottom outlet trough is adapted to provide support to the piping.

4. The side wall seal of claim 1 wherein the bottom outlet trough includes a wall having first and second stanchions on each side of the wall and a first support member on the first stanchion and a second support member on the second stanchion, wherein the bar is adapted to seat on the first and second support members.

5. The side wall seal of claim 1 wherein the gasket includes a receptacle for receiving and holding the bar by friction fit.

6. The side wall seal of claim 1 wherein the gasket includes a tongue and groove connection adapted to allow the gasket to be opened to fit over the piping and thereafter be closed by fastening the tongue to the groove.

7. The side wall seal of claim 1 wherein the bottom outlet trough and the gasket include one or more corresponding apertures for receiving fasteners to secure the bottom outlet trough and the gasket to the side wall of the building.

8. The side wall seal of claim 7 wherein the top cover covers the bottom outlet trough and gasket and the fasteners are hidden from view.

9. The side wall seal of claim 4 wherein the first and second support members include vertical grooves adapted to receive corresponding first and second ribs on the top cover for attaching the top cover to the bottom outlet trough.

10. The side wall seal of claim 1 wherein the downward angle is about a 90 degree angle.

11. The side wall seal of claim 1 wherein the piping comprises a single pipe or multiple pipes.

12. A plastic side wall seal for piping exiting a building side wall and providing a water resistant seal comprising
a flexible gasket adapted to be attached to the building side wall and having an opening through which the piping extends,
a bar adapted to fit into the gasket and wherein the gasket includes a receptacle for receiving and holding the bar by friction fit,
a bottom outlet trough adapted to be attached to the gasket, the bottom outlet trough having a bottom trough extending at an angle downward and adapted to receive and support the piping, and
a top cover adapted to fit over the bottom outlet trough and having an upper trough corresponding to the bottom trough,
wherein the gasket is connected to the building, the bar seats in the receptacle of the gasket and the bottom outlet trough, and the top cover fits over the bottom outlet trough to cover and seal the piping exiting the building side wall.

13. The side wall seal of claim 12 wherein the bottom outlet trough includes a wall having first and second stanchions on each side of the wall and a first support member on the first stanchion and a second support member on the second stanchion, wherein the bar is adapted to seat on the first and second support members.

14. The side wall seal of claim 13 wherein the gasket includes a tongue and groove connection adapted to allow the gasket to be opened to fit over the piping and thereafter be closed by fastening the tongue to the groove.

15. The side wall seal of claim 14 wherein the bottom outlet trough and the gasket include one or more corresponding apertures for receiving fasteners to secure the bottom outlet trough and the gasket to the side wall of the building.

16. The side wall seal of claim 15 wherein the top cover covers the bottom outlet trough and gasket and the fasteners are hidden from view.

17. The side wall seal of claim 16 wherein the first and second support members include vertical grooves adapted to receive corresponding first and second ribs on the top cover for attaching the top cover to the bottom outlet trough.

18. The side wall seal of claim 17 wherein the downward angle is about a 90 degree angle.

19. The side wall seal of claim 18 wherein the piping comprises a single pipe or multiple pipes.
